(19) United States
(12) Patent Application Publication
(10) Pub. No.: US 2025/0310873 A1
(43) Pub. Date: Oct. 2, 2025

(54) TECHNIQUES TO FACILITATE POWER MANAGEMENT FOR ACCESS POINTS OF A WIRELESS LOCAL AREA NETWORK

(71) Applicant: Cisco Technology, Inc., San Jose, CA (US)

(72) Inventors: Carlos M. Pignataro, Cary, NC (US); Srinath Gundavelli, San Jose, CA (US); Sangram Kishore Lakkaraju, Panathur (IN)

(21) Appl. No.: 18/621,651

(22) Filed: Mar. 29, 2024

(51) Int. Cl. H04W 52/02; H04W 76/20; H04W 84/12

(52) U.S. Cl. CPC H04W 52/0206; H04W 76/20; H04W 84/12

(57) ABSTRACT

Provided herein are techniques to facilitate power management for access points of a wireless local area network. In one example, a method may include obtaining capability information for each of one or more devices wirelessly connected to an access point of a wireless local area network; determining a power policy for the access point based, at least in part, on the capability information obtained for each of the one or more devices wirelessly connected to the access point; and enforcing the power policy for the access point, wherein the enforcing includes maintaining the access point in a full-power state or causing the access point to operate in a low-power state.

### TECHNICAL FIELD

The present disclosure relates to network equipment and services.

### BACKGROUND

Networking architectures have grown increasingly complex in communications environments, particularly wireless networking environments. As wireless networks grow, the power/energy consumption for operating such networks increases. As wireless network operators become more cost or energy conscious regarding the power/energy consumption of wireless networks, new opportunities exist regarding the power management of such networks.

### BRIEF DESCRIPTION OF THE DRAWINGS

FIG. 1A is a block diagram of a system that may be implemented to facilitate power management for access points of a wireless local area network (WLAN), according to an example embodiment.

FIG. 1B is a schematic diagram illustrating an example message format that can be utilized for various wireless device communications in accordance with embodiments herein.

FIG. 1C is a diagram illustrating example capability information and power policies that can be generated to facilitate power management for the access points of the WLAN of FIG. 1A, according to an example embodiment.

FIG. 2 is a diagram illustrating capability and policy layers that may be provided in order to facilitate power management for access points of a wireless local area network, according to an example embodiment.

FIG. 3 is a flow chart depicting a method according to an example embodiment.

FIG. 4 illustrates a hardware block diagram of a computing device configured to perform functions associated with operations discussed in connection with embodiments herein.

### DETAILED DESCRIPTION

### Overview

Embodiments herein provide techniques to facilitate efficient power management for access points (APs) of a wireless local area network (WLAN), such as an Institute of Electrical and Electronics Engineers (IEEE) 802.11 WLAN or Wi-Fi® network.

In at least one embodiment, a computer-implemented method is provided that may include obtaining capability information for each of one or more devices wirelessly connected to an access point of a wireless local area network; determining a power policy for the access point based, at least in part, on the capability information obtained for each of the one or more devices wirelessly connected to the access point; and enforcing the power policy for the access point, wherein the enforcing includes maintaining the access point in a full-power state or causing the access point to operate in a low-power state.

### Example Embodiments

In a wireless local area network (WLAN), one or more wireless access points (APs) provide wireless Radio Frequency (RF) coverage over which one or more wireless devices (e.g., phones, printers, cameras, etc.) can connect to the APs in order to connect to one or more data networks (e.g., the public Internet, an enterprise network operated by an enterprise entity (e.g., a business, institution, university, etc.), and/or the like. When operated in a full-power state, the power consumption of wireless APs (more generally referred to herein as ‘APs’) can be significantly higher than when operated in a low-power or sleep state. Thus, operators of WLANs are motivated to manage the power consumption of APs.

Current solutions having the goal of AP power management in wireless local area networks (WLANs) can be divided into two categories, such as ‘infrastructure-up’ (more generally, ‘bottom-up’) solutions and ‘controller-down’ (more generally, ‘top-down’) solutions. Generally, ‘infrastructure-up’ solutions often involve an AP making decisions regarding its power states. In contrast, ‘controller-down’ solutions often involve a controller deciding an AP power state and instructing the AP regarding its power states.

Enterprise wireless LAN systems have adopted techniques that purport to facilitate efficient AP power management and energy optimization using such conventional top-down/bottom-up approaches including time-based power management approaches (e.g., changing AP power states based on days, time of day, etc.) and/or approaches based on the number of users/wireless devices (also referred to herein as ‘clients’) connected to APs. For example, such a conventional AP power management approach may involve the network detecting a condition in which there may be no associated clients of a given AP and applying a power saving configuration based on no clients being connected to the AP. The power saving configuration can result in the AP going into a low-power or sleep mode/state such that the AP may be completely powered off or may turn off certain wireless/RF radio(s).

Typically, AP power management decisions regarding powering off an AP are made with regard to ensuring that there is no client impact based on powering off the AP. However, there may be instances in some environments, such as offices, factory floors, or the like in which some wireless devices may always be present/connected to an AP, which can prevent the enforcement of such a static ‘number of users’ basis for power management decisions.

Thus, there can be shortcomings to the top-down and bottom-up AP power management approaches that may hinge on the management of AP power states based on the number of users/wireless devices connected to APs and/or through static time-based approaches. Such static approaches for AP power management cannot respond to nuances and dynamics of mobile wireless networks.

While such ‘infrastructure-up’ and ‘controller-down’ solutions may be useful in some circumstances, a third perspective exists that may be utilized to facilitate AP power management, referred to herein as a ‘policy-centered’ approach or solution, as presented through embodiments herein. The ‘policy-centered’ AP power management approach as presented through embodiments herein does not suffer shortcomings of purely top-down or purely bottom-up approaches.

In accordance with embodiments herein, a policy engine or server can be provided that may facilitate a sustainability system that may operate to facilitate power optimization decisions and instructions through the generation of AP power policies that can be enforced for APs in a WLAN. In various embodiments, the policy server may obtain capability advertisements from APs, controllers, and/or wireless devices in a WLAN. The capability advertisements (e.g., messages) may include sustainability capability information from which the policy server can derive or otherwise generate power policies to facilitate the power management of APs within the WLAN. As discussed for embodiments herein, power policies generated by the policy server can include any combination of single and/or nested policies, also referred to herein as conditional policies.

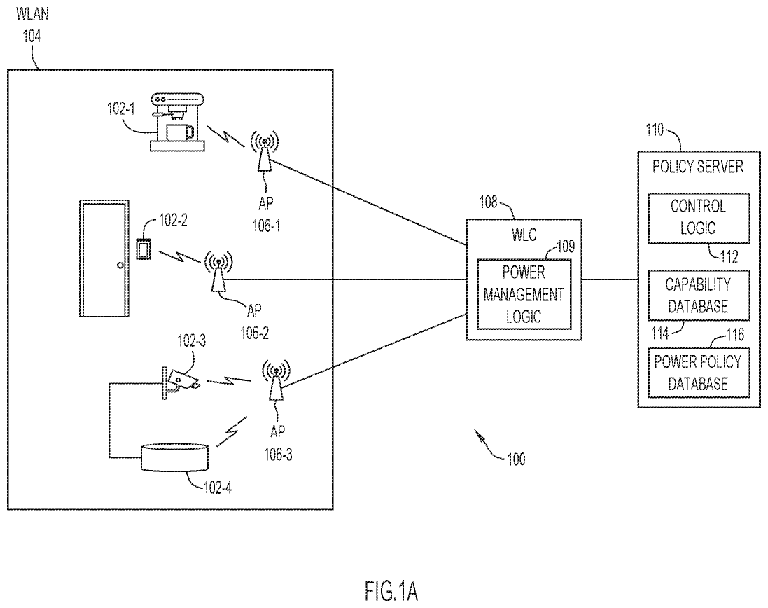

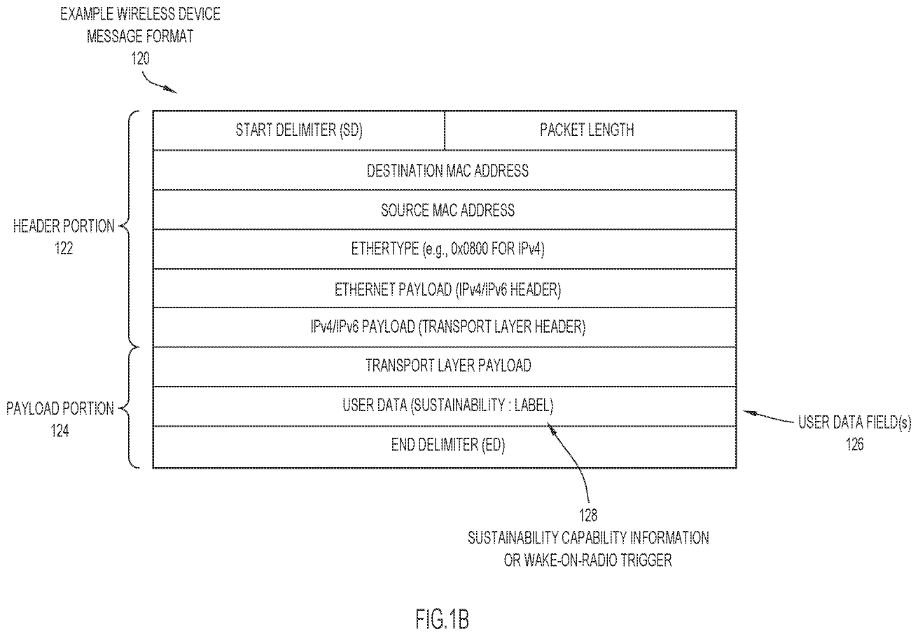

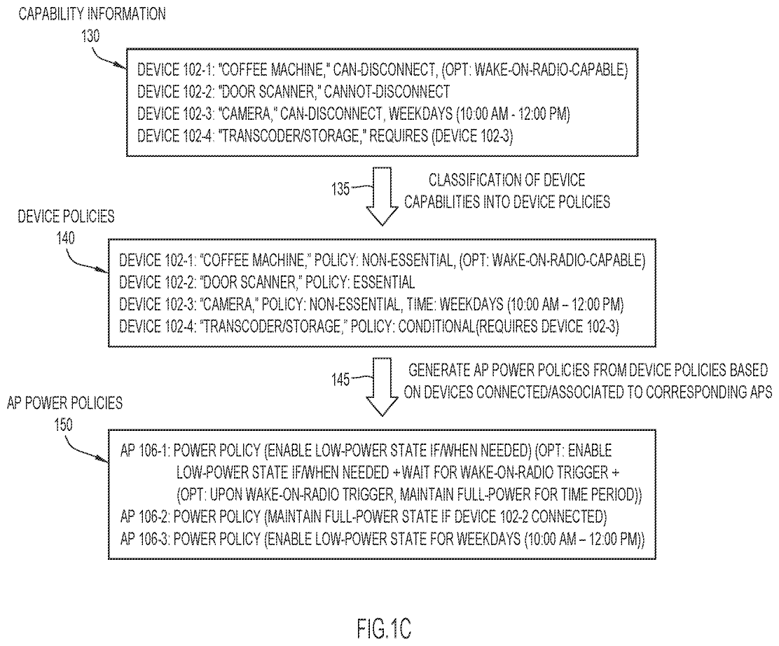

Referring to FIG. 1A, FIG. 1A is a block diagram of a system 100 that may be implemented to facilitate power management for access points of a wireless local area network, according to an example embodiment. FIG. 1B is a schematic diagram illustrating an example message format that can be utilized for various wireless device communications in accordance with embodiments herein. FIG. 1C is a diagram illustrating example capability information and power policies that can be generated to facilitate power management for the access points of the WLAN of FIG. 1A, according to an example embodiment, and is discussed with reference to FIG. 1A.

In at least one embodiment, system 100 may include a WLAN 104, a wireless LAN controller (WLC) 108, and a policy server 110. WLC 108 may include power management logic 109. Policy server 110 may include control logic 112, a capability database 114, and a power policy database 116. WLAN 104 may include a number of WLAN APs, such as an AP 106-1, an AP 106-2, and an AP 106-3 that may provide wireless RF coverage for WLAN 104 through which one or more wireless devices can wirelessly connect to any of APs 106-1-106-3. Each of AP 106-1, 106-2, and 106-3 can interface with WLC 108, which can further interface with policy server 110.

A number of wireless devices are also illustrated for WLAN 104 for purposes of illustration only in order to discuss various features of embodiments herein, including a wireless device 102-1 that may be capable of wirelessly connecting to AP 106-1 via a WLAN RF connection; a wireless device 102-2 that may be capable of wirelessly connecting to AP 106-2 via a WLAN RF connection; as well as a wireless device 102-3 and a wireless device 102-4 that may be capable of wirelessly connecting to AP 106-3 via corresponding WLAN RF connections. It is to be understood that any number of wireless devices and/or any number of WLAN APs may be present in system 100.

Generally, for system 100, WLC 108 may communicate with and control/manage APs 106-1, 106-2, and 106-3, which can include enforcing (e.g., via power management logic 109) one or more power policies generated by policy server 110 to provide power management for the APs 106-1-106-3. WLC 108 may also serve as a bridge to transport traffic for wireless devices communicated between WLAN 104/APs 106-1-106-3 and one or more data networks (not shown), which may include one or more wide area networks (WANs), such as the public Internet, one or more LANs, such as enterprise networks, and/or the like. In some instances, all or a portion of power management logic 109 (e.g., a power management application) can be provided via policy server 110.

WLAN APs, such as APs 106-1-106-3 may include, but not be limited to, any hardware and/or software capable of performing baseband signal processing (such as modulation/demodulation) as well as hardware (e.g., baseband processors (modems), transmitters and receivers, transceivers, and/or the like)), software, logic and/or the like to facilitate signal transmissions and signal receptions, via antenna assemblies (not shown) or the like in order to provide wireless communications that may be considered long-range wireless communications, such as, but not limited to, IEEE 802.11/Wi-Fi (including any variations thereof) wireless communications, Bluetooth® wireless communications, or the like. APs 106-1-106-3 may also include any hardware and/or software capable of performing wired communications, such as Ethernet drivers, Ethernet ports, and/or any other I/O elements capable of facilitating wired communications (e.g., with WLC 108).

A wireless device, such as any of wireless devices 102-1-102-4, or any other wireless devices discussed herein, may be considered any electronic device, etc. that initiates a connection or communication session with a wireless network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a router or gateway with a wireless interface, a wireless enabled device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more wireless networks, such as any of APs 106-1-106-3.

Generally, during operation of WLAN 104, wireless devices can perform 802.11 association and authentication procedures via a given AP in order to wirelessly attach/connect to the WLAN, which may be under control and configuration of WLC 108 and policy server 110, such that the wireless devices can establish communication sessions within system 100. Once authenticated, wireless devices may exchange packets/communications with one or more networks, as well as WLC 108 and policy server 110 during the communication sessions. Each of AP 106-1, 106-2, and 106-3 and WLC 108 may also exchange packets/communications with policy server 110 in accordance with embodiments herein.

In at least one embodiment, policy server 110 may be implemented as an Authentication, Authorization, and Accounting (AAA) server. In at least one embodiment, policy server may be implemented as an Identity Services Engine (ISE), as provided by Cisco®. Cisco® is a registered trademark of Cisco Systems, Inc. and/or its affiliates in the United States and certain other countries.

In an enterprise environment (e.g., an enterprise floor) there can be any number of wireless devices that may be present, such as Internet of Things (IoT) sensors, mobile devices, fixed devices, etc. Some of the devices may be classified as essential or critical devices (or, in another sense, high priority) and some may be marked as non-essential or non-critical devices (or, in another sense, low priority).

In some instances, if operating under traditional static-based AP power management approaches, the presence of non-essential devices being connected to an AP could force a power management function to not switch such APs to a low-power mode or state. For example, in the context of current solutions for AP power management in WLANs (as well as in private cellular architectures, such as private Fifth Generation (P5G) cellular architectures), two power management models are often prescribed: (1) devices independently (or at best communicating with neighbors) enter into a low-power or “almost off” state; or (2) statically configuring one or more central controllers' times to schedule up-down powering for APs.

However, in some instances, it may be useful to shut-off, remove, or otherwise manage wireless connectivity to an AP for a Wi-Fi sensor, a printer, or a coffee machine or some other non-essential resource if there is no activity on a floor. Further, there may be other scenarios, such as the presence (or lack thereof) of a primary device connected (or not connected) to an AP for which the connectivity of one or more secondary devices to the AP may depend, which may also be useful in managing AP power/energy consumption.

In accordance with embodiments herein, policy server 110 via control logic 112, capability database 114, and power policy database 116 may facilitate a capability layer a policy layer through which power manage may be provided for APs 106-1, 106-2, and 106-3 of WLAN 104.

Broadly, during operation of system 100, wireless device 102-1-102-6 and, in some instances, APs 106-1-106-3, and/or WLC 108 can advertise to the capability layer sustainability capability information that can be stored via capability database 114 and be used by the policy layer (e.g., policy server 110/control logic) to generate sustainability policies, also referred to interchangeably herein as power management policies, that can be used to facilitate the power management of APs 106-1, 106-2, and 106-3.

Sustainability capability information advertised by any of wireless devices 102-1-102-4 and/or APs 106-1-106-3 towards policy server 110 can be provided in any manner in accordance with embodiments herein and stored via capability database 114 in order to facilitate the generation of power policies for the APs 106-1-106-3. In various embodiments, advertised sustainability capability information obtained from a device (e.g., any of wireless devices 102-1-102-4 and/or APs 106-1-106-3) by policy server 110 may include information provided in a format of “sustainability: label” in which the ‘label’ portion of the advertised information may indicate “can-turn-off,” “can-disconnect,” “essential,” “non-essential,” “foobar,” “device-type” (e.g., coffee maker, appliance, printer, camera, etc.), “wake-up mode information,” “sleep information,” “dependency information,” “wake-on-radio capable” (or wake-up-on-radio capable), combinations thereof (e.g., multiple advertisements or multiple sustainability labels provided by a given device) and/or any other label that may disambiguate of a label for use in determining/generating power policies. In some embodiments, advertised sustainability capability information may additionally include suggested on-off times, for example, times for which a device may be disconnected/connected, turned on/off, and/or the like.

Referring to FIG. 1B, FIG. 1B is a diagram illustrating an example message format 120 that can be utilized for various communications in accordance with embodiments herein such as, for example, for any of wireless devices 102-1, 102-2, 102-3, and/or 102-4 advertising capability information towards policy server 110. As shown in FIG. 1B, the example message format 120 may include a header portion 122 including one or more header fields (e.g., a start delimiter field, a packet length indication field, destination/source address fields, Ethernet header fields (for IPV4 and/or Ipv6 headers), transport layer header fields, etc.) and a payload portion 124 including one or more payload fields (e.g., transport layer payload field(s) and user data field(s), as well as an end delimiter field).

In accordance with embodiments herein, the payload portion 124 may include one or more user data fields 126 that can be used to carry sustainability capability information and/or wake-on-radio trigger (discussed in further detail below), labeled 128 in FIG. 1B, in accordance with embodiments herein. Any number of sustainability label(s) may be advertised/carried via user data field(s) 126 in accordance with embodiments herein.

Various operations may be utilized in accordance with embodiments herein to facilitate capability advertisements by wireless devices. In some embodiments, a wireless device may include its sustainability preferences in the form of one or more sustainability label(s) (sustainability capability information) in a WLAN/802.11 probe request or association request. In some embodiments, a wireless device may also use an 802.11 action frame to indicate the one or more sustainability label(s) (sustainability capability information), potentially, in an on-demand manner.

In still some embodiments, an AP may also communicate an indication of sustainability capabilities of the WLAN 104 (network) or for a given Basic Service Set (BSS) to wireless device(s), for example indicating that the WLAN/BSS is capable of or supports power management operations (for one or more APs, etc.) based on obtaining sustainability capability information from wireless device(s). In various embodiments, an AP can indicate that a WLAN/BSS support for power management operations via any combination of 802.11 beacon frames, in a probe response to a probe request, and/or via 802.11 action frames. Upon receiving such an indication from an AP, a given wireless device can communicate/advertise its sustainability capability labels to the AP/network. Thus, embodiments herein may include providing to wireless devices an indication that power management capabilities/support are provided for the WLAN 104 (e.g., a packet/frame sent to wireless devices including a sustainability label of “sustainability: power-management-capable-WLAN” or the like).

In still some embodiments, a wireless device may discover sustainability capabilities of a WLAN/BSS by sending an Access Network Query Protocol (ANQP) query using a Generic Advertisement Service (GAS) request frame to an AP. In response, the AP can send a GAS response frame indicating its capability with respect to sustainability capabilities (e.g., power management capable, etc.). Upon obtaining the response, the wireless device can communicate/advertise its sustainability capability labels to the AP/network.

Other variations for indicating sustainability support to a wireless device (e.g., a flag, control word, bit, etc. indicating power management support via the WLAN for one or more APs, etc.) provided one or more wireless communications and/or advertising sustainability preferences (sustainability capability information) by a wireless device to an AP/network/system (e.g., via one or more labels may) be envisioned in accordance with embodiments herein such that one or more power management actions, policies, and/or the like can be generated, executed, or enforced in a network considering wireless device capabilities/policy preferences

Based on the obtained sustainability capability information for devices of system 100 that are connected to each of the APs 106-1-106-3, the policy server 110, via control logic 112, can generate power policies that can be enforced for each of the APs by the WLC 108, via power management logic 109 (e.g., transitioning corresponding APs 106-1-106-3 to different power states based on their corresponding AP power policies). Stated differently, the policy server 110 can generate and publish power policies to the policy layer that can be consumed/enforced in order to manage power states of APs 106-1-106-3.

Consider an example through which embodiments of the present disclosure may be illustrated through which capability information can be advertised to the capability layer to enable the policy server 110 can learn of conditions for 802.11 associations and for traffic that may be present within WLAN 104. For the present example, consider that wireless device 102-1 is a coffee machine that connects/associates to AP 106-1 and advertises sustainability capability information that is obtained by the policy server 110, such as “sustainability: can-disconnect.” Further, consider that wireless device 102-2 is a door scanner (for managing secure access into a room) that connects/associates to AP 106-2 advertises sustainability capability information that is obtained by the policy server 110, such as “sustainability: cannot-disconnect.” Further, consider that wireless device 102-3 is a camera that connects/associates to AP 106-3 and advertises sustainability capability information that is obtained by the policy server 110, such as “sustainability: can-disconnect (10:00 AM-12:00 PM, weekdays)” that includes time-basc/temporal capability information indicating that the camera can be disconnected from 10:00 AM to 12:00 PM on weekdays. Additionally, consider that wireless device 102-4 is a transcoder/storage device whose operation is dependent/conditional on the operation of wireless device 102-2 (camera) that also connects/associates to AP 106-3 and advertises sustainability capability information that is obtained by the policy server 110, such as “sustainability: requires (device 102-3).”

Referring to FIG. 1C, FIG. 1C illustrates example capability information 130 that can be stored via capability database 114 based on the capability information obtained from each of wireless devices 102-1-102-4. In some embodiments, if not advertised by a given wireless device the device type of the wireless devices can be populated for the capability information by a network administrator, automatically on based credentials (e.g., exchanged during association/authentication), and/or based on a media access control (MAC) address of wireless device exchanged with a given AP/WLC 108 (e.g., performing a lookup on a device type database during association, authentication, etc.), combinations thereof, and/or the like. In some embodiments, sustainability capability information such as various labels, preferences, etc. of a wireless device, if not advertised by the wireless device, may also be populated in the capability information 130 for the capability database 114 by a network administrator, automatically based on credentials (e.g., exchanged during association/authentication), and/or based on a MAC address of wireless device exchanged with a given AP/WLC 108 (e.g., performing a lookup on a device type database during association, authentication, etc.), combinations thereof, and/or the like.

Based on the capability information obtained from/for each of wireless devices 102-1-102-4, policy server 110, via control logic 112, can perform classification of the wireless devices based on their advertised (sustainability) capability information and/or any other information obtained for the devices, as generally shown at 135, in order to generate device policies 140 from which AP power policies 150 for APs 106-1, 106-2, and 106-3 can be generated, as generally shown at 145, based on the wireless device(s) that are connected/associated to each of the APs. The device policies 140 and the AP power policies 150 can be pushed/published by policy server 110 to the policy layer/stored via power policy database 116 and enforced via WLC 108/power management logic 109 in order to facilitate power management of APs 106-1-106-3 within system 100. In some instances, WLC 108 and/or any other controllers that may be present within system 100 may also generate/publish various policies that can also be pushed to the policy layer.

Device classification can be a policy component performed by the policy server 110 to generate the device policies 140 can performed through a variety of techniques. In the simplest case, for example, policy server 110 can classify devices as either being “essential” or “critical” devices versus “non-essential” or “non-critical” devices such that essential/critical devices may be considered devices that cannot be powered-down, cannot be caused to disconnect from an AP, or may otherwise be considered as not capable of being disconnected from an AP (or may only be powered-down/disconnected under certain circumstances/conditions/times of day/etc.), whereas non-essential/non-critical devices may be considered devices that can be powered-down, caused to disconnect from an AP, or may otherwise be considered as capable of being disconnected from an AP. Thus, policy server 110 can potentially provide a classification tag that indicates whether a given wireless device is considered an essential or a non-essential device, as illustrated via device policies 140.

In at least one embodiment, essential/non-essential classifications may be determined by the policy server 110 based on the type of different wireless devices. For example, a coffee machine (e.g., wireless device 102-1) may be classified as non-essential while a thermostat or door scanner (e.g., wireless device 102-2) may be classified as essential.

Other criteria can be used by policy server 110 to make an essential/non-essential classification. In at least one embodiment, policy server 110 can determine that wireless device 102-1 is to be classified as a non-essential device based on the device advertising the “can-disconnect” capability information and can determine that wireless device 102-2 is to be classified as an essential device based on the device advertising the “cannot-disconnect” capability information.

Other device policies that can be determined for wireless devices by policy server 110 may include conditional policies that can be determined from usage of the “requires” construct within advertised capabilities of a wireless device. For example, the “requires (Device 102-3)” capability information advertised by wireless device 102-4 can be used by policy server 110 to classify wireless device 102-4 into a conditional policy that identifies that wireless device 102-4 (transcoder/storage) is to receive wireless connectivity only when wireless device 102-3 (camera) is connected to the network.

Conditional policies can be extended to multiple devices in accordance with embodiments herein such that policy server 110 can build conditional sustainability policies for two or more network elements, referred to herein as a ‘System’ policy (meaning that two or more devices/conditions are to be satisfied for the ‘system’ to be up/triggered) which can be published as a nested condition to the policy layer. Such a system-level conditional policy may be expressed as: “Head-Device-1::Secondary-Device-1, Secondary-Device-2, Secondary-Device-3, && Secondary-Device-4.” In this example, if the Head-Device-1 is not connected to a given AP, then wireless services to all secondary devices can be disabled. Thus, for nested conditional policies, wireless connectivity services to a set (also referred to herein as ‘conditional set’ or a ‘conditional capability set’) of one or more (secondary) devices may be enabled only when a (conditional) set of one or more (primary) devices are present. In some instances, such a system-level conditional policy may be applicable in an industrial IoT environment, for example, in which a system may need robots 1-6 and output devices A-D for the system to operate such that, if any of the devices is not available, then all of the system elements can be disconnected/deactivated from wireless connectivity.

Other conditions, such as application type, time, location, etc. may be considered by policy server 110 in generating device policies 140 in accordance with embodiments herein. For example, within the context of the present example, policy server 110 can, based on the advertised capabilities obtained from wireless device 102-3, “can-disconnect (10:00 AM-12:00 PM, weekdays),” classify wireless device 102-3 as a non-essential device that can be disconnected from wireless connectivity from 10:00 AM-12:00 PM on weekdays.

Other variations of capability information and device policies can be envisioned in accordance with embodiments herein. For example, in some embodiments, some wireless devices within system 100 may be capable of generating and wirelessly transmitting a wake-on-radio trigger, such as a (special) packet, frame, or the like that contains a specific bit pattern, control word, or the like (e.g., as shown in FIG. 1B) that can be used to trigger an AP/edge device to energize or otherwise transition from a low-power state to a full-power state. For example, as shown in FIG. 1A, consider in one instance that wireless device 102-1 can advertise sustainability capability information such as “sustainability: wake-on-radio-capable” that identifies that wireless device 102-1 is capable of transmitting such a trigger to cause the AP to which the device can connect/associate (e.g., is within the RF coverage of the AP) in order to transition from a low-power state to a full-power state. In this example involving wireless device 102-1, based on such wake on radio capability information, policy server 110 can generate a policy for the device indicating the devices wake-on-radio capability information, which can be later used to generate an AP power policy for AP 106-1, as discussed in further detail below.

Although device policies 140 are illustrated with regard to wireless devices 102-1-102-4, in some instances APs 106-1, 106-2, and/or 106-3 can also advertise capability information from which device policies can be generated by policy. For example, in one scenario, policy server 110 may classify/identify one or more APs as non-essential APs that may have a high security risk indices such that the policy server 110 can evaluate conditional advertisements to further include other secondary devices in a conditional policy that are dependent on one or more primary devices as identified based on obtained wireless device sustainability capability information.

From device policies 140, policy server 110 can generate AP power policies 150 for each of AP 106-1, AP 106-2, and AP 106-3, which can be pushed to the policy layer/stored via power policy database 116 and enforced by WLC 108 via power management logic 109 (e.g., by transitioning corresponding APs to corresponding power states based on their corresponding AP power policies), for example, via power management logic.

Policy server 110 can generate AP power policies 150 based on device policies 140 through a variety of logic. In at least one embodiment, classification of non-essential devices by policy server 110 allows for the generation of one or more AP power policies for one or more APs, such as AP 106-1 and/or AP 106-3 in the present example, indicating that such devices are capable of being disconnected from their correspond APs; thereby causing power management logic 109 of WLC 108 to ignore connection of such non-essential devices (e.g., wireless device 102-1) if/when needed (e.g., during non-business hours for wireless device 102-1/AP 106-1 and/or from 10:00 AM-12:00 PM on weekdays for wireless device 102-3/AP 106-3, based on the time-based capability information obtained from wireless device 102-3) such that enforcing the one or more AP policies can include transitioning the corresponding AP(s) (e.g., AP 106-1 and/or 106-3) to a low-power state, if/as needed.

In at least one embodiment, classification of conditional devices by policy server 110 may similarly allow for the generation of an AP power policy that indicates that secondary device(s) belonging to a conditional set are capable of being disconnected from their corresponding APs when primary device(s) of the conditional set are not present, such the secondary device(s) can effectively be ignored when making power management decisions for corresponding APs with which such secondary device(s) may be connected/associated without the corresponding primary device(s) also being connected/associated to the corresponding APs, or if the corresponding primary device(s) are also capable of being disconnected (e.g., due to being classified as non-essential devices or other capability conditions, such as time-based conditions, etc.) managing AP power based on the combination of primary and secondary device capability information. Thus, based on determining that at least one primary device is not wirelessly connected to a given AP, enforcing an AP power policy for the AP can includes triggering the AP to enter into a low-power state even if at least one secondary device is wirelessly connected to the AP.

In the present example with regard to wireless device 102-4 (transcoder/storage for the camera), whose connectivity/operation is conditionally dependent on operation/connection (primary) wireless device 102-3 with AP 106-3, an AP power policy can be generated for AP 106-3 that ignores the presence of (secondary) wireless device 102-4 and instead facilitates management of the AP 106-3 power based on/in accordance with the capability information of the (primary) wireless device 102-3, which indicates that AP 106-3 may be transitioned to a low-power state at least between 10:00 AM and 12:00 PM on weekdays. Thus, complex AP power policies can be generated in accordance with embodiments herein that may take into consideration different sustainability capability information of multiple devices that may be connected/associated to one or more AP(s).

In at least one embodiment, classification of essential devices by policy server 110 allows for the generation of one or more AP power policies 150 for one or more APs, such as AP 106-2 involving wireless device 102-2 (door scanner), that may trigger the WLC 108/power management logic 109 to monitor the connectivity of essential device(s) (not capable of being disconnected) with a given AP such that enforcing an AP power policy for the given AP can include maintaining the AP in a full-power state or, maintaining the AP in a full power state unless one or more other conditions may be satisfied (e.g., off-business hours, holidays, etc.), for example based on other capability information that may be obtained for the essential device(s) and/or the AP(s) to which they are connected/associated.

Thus, based on determining that at least one device that is wirelessly connected to an AP is not capable of being disconnected from the AP, enforcing an AP power policy for the AP includes maintaining (e.g., by WLC 108/power management logic 109) the AP in a full-power state; whereas, based on determining that every device that is wirelessly connected to the AP is capable of being disconnected from the AP, enforcing the AP power policy for the access point can include triggering the AP to enter into the low-power state.

Still more enhanced AP power policies can be envisioned for determining when to make a shutdown call/transitioning an AP to a low-power state. For example, consider that policy server 110 obtains capability information from a given wireless device, such as wireless device 102-1, which, in one instance, may advertise sustainability capability information, such as “sustainability: wake-on-radio-capable” that identifies that wireless device 102-1 is capable of wirelessly transmitting a wake-on-radio trigger (e.g., a special packet/frame containing a special control word, bit pattern or the like) based on wake-on-radio control logic (not shown) configured for the wireless device 102-1 in which the trigger can be used to cause a given AP to which the device can or seeks to connect/associate (e.g., AP 106-1, in this example) to transition from a low-power state to a full-power state. For example, with reference to FIG. 1B, wireless device 102-1 may transmit a message including a user data field 126 that includes a “sustainability: WAKE-UP-NOW” label (or the like, which may be formatted as a particular bit string, control word, etc.) that can be used to cause AP 106-1 to which wireless device 102-1 seeks to connect to transition from a low-power state to full-power state.

In this example, an AP power policy may be generated with regard to AP 106-1 for device 102-1, which can be classified as a non-essential device, such that enforcement of the AP power policy for AP 106-1 can include transitioning the AP 106-1 to a low-power state (from a full-power state) if/when needed and configuring the AP 106-2 to remain in the low-power state until a wake-on-radio trigger (e.g., “sustainability: WAKE-UP-NOW”) is received from device 102-1 that seeks to connect with the AP 106-2 (or potentially any device that may seek to connect with the AP 106-2), upon which the AP 106-2 can be caused to transition back to the full-power state. In at least one embodiment, the AP power policy for AP 106-1 could still further be enhanced to indicate that, upon receiving the wake-on-radio trigger from the device 102-1, the AP 106-2 may be maintained at the full-power state for a certain time period (e.g., 4 hours, etc.). It is to be understood that logic can be provided for APs 106-1, 106-2, and 106-3, and/or any other elements of system 100 in order to enable operation of such wake-on-radio features (e.g., to identify/recognize a special wake-on-radio trigger (e.g., packet/frame including a wake-on-radio trigger) and to trigger a certain behavior, such as transitioning from a low-power state to a full-power state, exchanging communications with WLC 108/power management logic 109 regarding configuration of an AP to wait for such a trigger and/or transmitting an indication to WLC 108 (by the AP) such a trigger has been received, etc.).

Accordingly, multiple aspects to facilitate AP power management may be provided in accordance with embodiments herein. Embodiments herein may leverage different policies as an energy efficiency control point that can be used in a variety of wireless networks, such as WLANs and/or private 5G (P5G) networks.

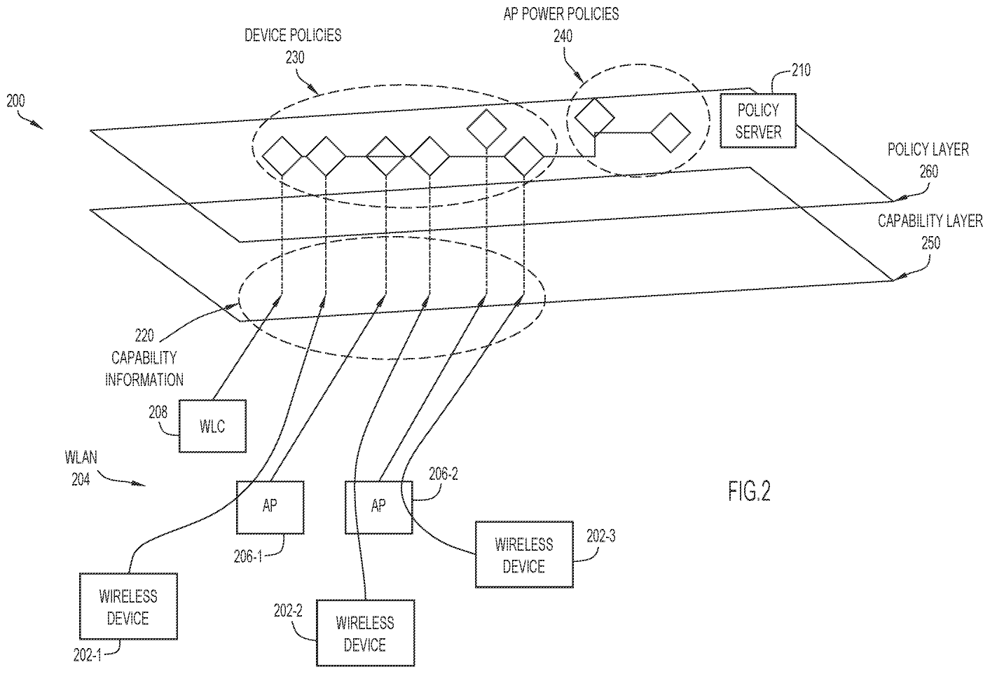

Referring to FIG. 2, FIG. 2 is a diagram of a system 200 illustrating capability and policy layers that may be provided in order to facilitate power management for APs 206-1 and 206-2 of a WLAN 204 of the system 200, according to an example embodiment. In at least one embodiment, system 200 may include a policy server 210, a WLC, and a WLAN 204 including an AP 206-1 and an AP 206-2, as well as a number of wireless devices, 202-1, 202-2, and 202-3. As illustrated in FIG. 2 and in accordance with embodiments herein, system 200 via policy server 210 may facilitate a capability layer 250 and a policy layer 260, which may also be referred to as a ‘green policy creation layer’, for example, to facilitate the implementation of green/energy saving initiatives/policies.

During operation of system 200, as similarly discussed for system 100 of FIG. 1A, devices of system 200, including any combination of wireless device 202-1, wireless device 202-2, wireless device 202-3, AP 206-1, AP 206-2, and/or WLC 208 can advertise capability information, generally illustrated as capability information 220, to the capability layer 250 (e.g., stored via a capability database (not shown) of policy server 210).

The policy server 210 can utilize the capability information 220 to perform classification at least of wireless devices 202-1, 202-2, and 202-3, and potentially of AP 206-1, 206-2, and/or WLC 208 in order to generate device policies, generally illustrated as device policies 230, from which the policy server can further generate AP power policies, generally illustrated as AP power policies 240, that can be pushed to the policy layer 260 to facilitate management of power/energy consumption for APs 206-1 and 206-2. For example, WLC 208 may consume the AP power policies 240 in order to facilitate management of power/energy consumption for APs 206-1 and 206-2 in accordance with embodiments herein.

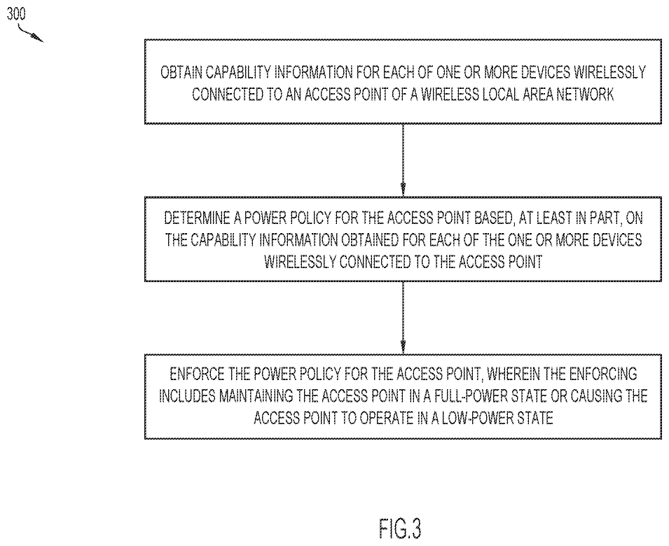

Referring to FIG. 3, FIG. 3 is a flow chart depicting a method 300, according to an example embodiment. In at least one embodiment, method 300 illustrates operations that may be performed by a policy server for a WLAN, such as policy server 110 for WLAN 104, in order to facilitate power management of APs 106-1, 106-2, and 106-3 in the WLAN 104, as shown in FIG. 1A, according to an example embodiment.

At 302, the method may include obtaining capability information for each of one or more devices wirelessly connected to an access point of a wireless local area network. As shown at 304, the method may include determining a power policy for the access point based on the capability information obtained for each of the one or more devices wirelessly connected to the access point. As shown at 306, the method may include enforcing the power policy for the access point, wherein the enforcing includes maintaining the access point in a full-power state or causing the access point to operate in a low-power state.

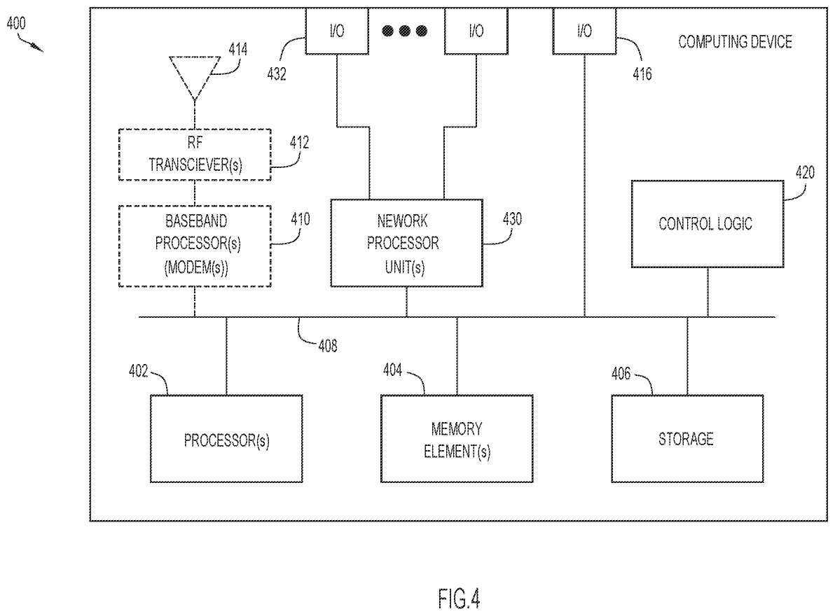

Referring to FIG. 4, FIG. 4 illustrates a hardware block diagram of a computing device 400 that may perform functions associated with operations discussed herein in connection with the techniques described for embodiments herein. In various embodiments, a computing device or apparatus, such as computing device 400 or any combination of computing devices 400, may be configured as any entity/entities in order to perform operations of the various techniques discussed for embodiments herein, such as any elements, functions, etc. discussed for embodiments herein (e.g., wireless devices 102-1-102-4, APs 106-1-106-3, WLC 108, and/or policy server 110).

In at least one embodiment, the computing device 400 may be any apparatus that may include one or more processor(s) 402, one or more memory element(s) 404, storage 406, a bus 408, one or more network processor unit(s) 430 interconnected with one or more network input/output (I/O) interface(s) 432, one or more I/O interface(s) 416, and control logic 420. In various embodiments, instructions associated with logic for computing device 400 can overlap in any manner and are not limited to the specific allocation of instructions and/or operations described herein.

For embodiments in which computing device 400 may be implemented as any device capable of wireless communications, computing device 400 may further include at least one baseband processor or modem 410, one or more radio RF transceiver(s) 412 (e.g., any combination of RF receiver(s) and RF transmitter(s)), one or more antenna(s) or antenna array(s) 414.

In at least one embodiment, processor(s) 402 is/are at least one hardware processor configured to execute various tasks, operations and/or functions for computing device 400 as described herein according to software and/or instructions configured for computing device 400. Processor(s) 402 (e.g., a hardware processor) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 404 and/or storage 406 is/are configured to store data, information, software, and/or instructions associated with computing device 400, and/or logic configured for memory element(s) 404 and/or storage 406. For example, any logic described herein (e.g., control logic 420) can, in various embodiments, be stored for computing device 400 using any combination of memory element(s) 404 and/or storage 406. Note that in some embodiments, storage 406 can be consolidated with memory element(s) 404 (or vice versa) or can overlap/exist in any other suitable manner.

In at least one embodiment, bus 408 can be configured as an interface that enables one or more elements of computing device 400 to communicate in order to exchange information and/or data. Bus 408 can be implemented with any architecture designed for passing control, data and/or information between processors, memory elements/storage, peripheral devices, and/or any other hardware and/or software components that may be configured for computing device 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 430 may enable communication between computing device 400 and other systems, entities, etc., via network I/O interface(s) 432 (wired and/or wireless) to facilitate operations discussed for various embodiments described herein. In various embodiments, network processor unit(s) 430 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 400 and other systems, entities, etc. to facilitate operations for various embodiments described herein. In various embodiments, network I/O interface(s) 432 can be configured as one or more Ethernet port(s), Fibre Channel ports, any other I/O port(s), and/or antenna(s)/antenna array(s) now known or hereafter developed. Thus, the network processor unit(s) 430 and/or network I/O interface(s) 432 may include suitable interfaces for receiving, transmitting, and/or otherwise communicating data and/or information (wired and/or wirelessly) in a network environment.

I/O interface(s) 416 allow for input and output of data and/or information with other entities that may be connected to computing device 400. For example, I/O interface(s) 416 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 400 is implemented as a wireless device or any apparatus capable of wireless communications, the RF transceiver(s) 412 may perform RF transmission and RF reception of wireless signals via antenna(s)/antenna array(s) 414, and the baseband processor or modem 410 performs baseband modulation and demodulation, etc. associated with such signals to enable wireless communications for computing device 400.

In various embodiments, control logic 420 can include instructions that, when executed, cause processor(s) 402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 404 and/or storage 406 can store data, software, code, instructions (e.g., processor instructions), logic, parameters, combinations thereof, and/or the like used for operations described herein. This includes memory element(s) 404 and/or storage 406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include obtaining capability information for each of one or more devices wirelessly connected to an access point of a wireless local area network; determining a power policy for the access point based, at least in part, on the capability information obtained for each of the one or more devices wirelessly connected to the access point; and enforcing the power policy for the access point, wherein the enforcing includes maintaining the access point in a full-power state or causing the access point to operate in a low-power state.

In one instance, obtaining the capability information for each of the one or more devices wirelessly connected to the access point includes obtaining the capability information via an advertisement of the capability information by at least one device. In at least one instance, the method may further include obtaining access point capability information from the access point, wherein the determining is based additionally on the access point capability information.

In at least one instance, determining the power policy for the access point further includes classifying the one or more devices based on the obtained capability information to generate a device policy for each of the one or more devices that indicates, at least in part, whether each of the one or more devices is capable of being disconnected from the access point.

In at least one instance, determining the power policy for the access point further comprises: determining, based on the capability information, whether any device that is wirelessly connected to the access point is capable of being disconnected from the access point. In at least on instance the method may further include, based on determining that at least one device that is wirelessly connected to the access point is not capable of being disconnected from the access point, enforcing the power policy for the access point includes maintaining the access point in the full-power state; or based on determining that every device that is wirelessly connected to the access point is capable of being disconnected from the access point, enforcing the power policy for the access point includes triggering the access point to enter into the low-power state.

In at least one instance, determining the power policy for the access point further comprises determining that at least one secondary device that is wirelessly connected to the access point is capable of being disconnected from the access point if at least one primary device is not wirelessly connected to the access point.

In at least one instance, the method may further include, based on determining that the at least one primary device is not wirelessly connected to the access point, enforcing the power policy for the access point includes triggering the access point to enter into the low-power state even if the at least one secondary device is wirelessly connected to the access point; and based on determining that the at least one primary device is wirelessly connected to the access point, enforcing the power policy for the access point includes maintaining the access point in the full-power state.

In at least one instance, the device policy generated for each of the one or more devices further indicates temporal information related to whether each of the one or more devices is capable of being disconnected from the access point. In at least one instance, the method may further include for the access point operating in the low-power state, obtaining a trigger from a particular device that seeks to connect with the access point, wherein the trigger causes the access point to enter into the full-power state. In at least one instance, enforcing the power policy for the access point may include transitioning the AP to a low-power state and configuring the AP to remain in the low-power state until a wake-on-radio trigger is received from a particular wireless device that seeks to connect or associate with the AP. In at least one instance, the method may further include providing to the one or more wireless devices an indication that power management capabilities are provided for the wireless local area network.

Accordingly, multiple aspects to facilitate AP power management may be provided in accordance with embodiments herein. Through capability advertisements of capability information (e.g., a super-set of “sustainability: label” device capabilities) for devices present within a WLAN, a policy layer (e.g., policy server 110) can derive single or nested device policies for the devices within the WLAN. For example, essential/non-essential classification can be provided to generate device policies, which can then be used to further generate AP power policies. Such an essential/non-essential classification can be used to facilitate powering-down a WLAN AP even if there are devices connected to the AP, for example, if the devices are classified as non-essential devices.

In another example, conditional policies can be provided in which connectivity to a set of one or more secondary devices is to be provided only when there is a set of one or more primary devices present/connected to a given AP, which may be useful in industrial IoT environments, environments in which shipping scanners need to be active only when shipping container(s) are on-site, etc. Thus, embodiments herein may leverage different policies, such as conditional policies, as an energy efficiency control point that can be used in a variety of wireless networks, such as WLANs and/or private 5G networks. Accordingly, device policies can be used, atomically and/or combined with others, in order for the policy layer to develop and instantiate a policy (e.g., low-power or moving out traffic as a non-preferred coloring, as a subset of non-essential devices).

### Variations and Implementations

In general, authentication services (e.g., as may be facilitated via WLC 108 and/or policy server 110/210) may include authenticating and/or authorizing one or more device(s) for one or more connections and/or communications and may be inclusive of any Authentication, Authorization, and Accounting (AAA) services that may be facilitated via any combination of authentication/authorization protocols such as Remote Authentication Dial-In User Service (RADIUS), DIAMETER, Extensible Authentication Protocol (EAP) [including any EAP variations], and/or the like. Generally, authentication refers to a process in which an entity's identity is authenticated, typically by providing evidence that it holds a specific digital identity such as an identifier/identity and corresponding credentials/authentication attributes/etc. Generally, authorization can be used to determine whether a particular entity is authorized to perform a given activity.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining capability information for each of one or more devices wirelessly connected to an access point of a wireless local area network;
determining a power policy for the access point based, at least in part, on the capability information obtained for each of the one or more devices wirelessly connected to the access point; and
enforcing the power policy for the access point, wherein the enforcing includes maintaining the access point in a full-power state or causing the access point to operate in a low-power state.

2. The method of claim 1, wherein obtaining the capability information for each of the one or more devices wirelessly connected to the access point includes:
obtaining the capability information via an advertisement of the capability information by at least one device.

3. The method of claim 1, further comprising:
obtaining access point capability information from the access point, wherein the determining is based additionally on the access point capability information.

4. The method of claim 1, wherein determining the power policy for the access point further comprises:
classifying the one or more devices based on the obtained capability information to generate a device policy for each of the one or more devices that indicates, at least in part, whether each of the one or more devices is capable of being disconnected from the access point.

5. The method of claim 4, wherein determining the power policy for the access point further comprises:
determining, based on the capability information, whether any device that is wirelessly connected to the access point is capable of being disconnected from the access point.

6. The method of claim 5, further comprising:
based on determining that at least one device that is wirelessly connected to the access point is not capable of being disconnected from the access point, enforcing the power policy for the access point includes maintaining the access point in the full-power state; or
based on determining that every device that is wirelessly connected to the access point is capable of being disconnected from the access point, enforcing the power policy for the access point includes triggering the access point to enter into the low-power state.

7. The method of claim 5, wherein determining the power policy for the access point further comprises:
determining that at least one secondary device that is wirelessly connected to the access point is capable of being disconnected from the access point if at least one primary device is not wirelessly connected to the access point.

8. The method of claim 7, further comprising:
based on determining that the at least one primary device is not wirelessly connected to the access point, enforcing the power policy for the access point includes triggering the access point to enter into the low-power state even if the at least one secondary device is wirelessly connected to the access point; and
based on determining that the at least one primary device is wirelessly connected to the access point, enforcing the power policy for the access point includes maintaining the access point in the full-power state.

9. The method of claim 4, wherein the device policy generated for each of the one or more devices further indicates temporal information related to whether each of the one or more devices is capable of being disconnected from the access point.

10. The method of claim 1, further comprising:
for the access point operating in the low-power state, obtaining a trigger from a particular device that seeks to connect with the access point, wherein the trigger causes the access point to enter into the full-power state.

11. The method of claim 1, further comprising:
providing to the one or more devices an indication that power management capabilities are provided for the wireless local area network.

12. One or more non-transitory computer readable storage media encoded with instructions that, when executed by a processor, cause the processor to perform operations, comprising:
obtaining capability information for each of one or more devices wirelessly connected to an access point of a wireless local area network;
determining a power policy for the access point based, at least in part, on the capability information obtained for each of the one or more devices wirelessly connected to the access point; and
enforcing the power policy for the access point, wherein the enforcing includes maintaining the access point in a full-power state or causing the access point to operate in a low-power state.

13. The media of claim 12, wherein determining the power policy for the access point further comprises:
classifying the one or more devices based on the obtained capability information to generate a device policy for each of the one or more devices that indicates, at least in part, whether each of the one or more devices is capable of being disconnected from the access point.

14. The media of claim 12, wherein the instructions, when executed by the processor, cause the processor to perform further operations, comprising:
for the access point operating in the low-power state, obtaining a trigger from a particular device that seeks to connect with the access point, wherein the trigger causes the access point to enter into the full-power state.

15. A system comprising:
at least one memory element for storing data; and
at least one processor for executing instructions associated with the data, wherein executing the instructions causes the system to perform operations, comprising:
obtaining capability information for each of one or more devices wirelessly connected to an access point of a wireless local area network;
determining a power policy for the access point based, at least in part, on the capability information obtained for each of the one or more devices wirelessly connected to the access point; and
enforcing the power policy for the access point, wherein the enforcing includes maintaining the access point in a full-power state or causing the access point to operate in a low-power state.

16. The system of claim 15, wherein obtaining the capability information for each of the one or more devices wirelessly connected to the access point includes:
obtaining the capability information via an advertisement of the capability information by at least one device.

17. The system of claim 15, wherein determining the power policy for the access point further comprises:
classifying the one or more devices based on the obtained capability information to generate a device policy for each of the one or more devices that indicates, at least in part, whether each of the one or more devices is capable of being disconnected from the access point; and
determining, based on the capability information, whether any device that is wirelessly connected to the access point is capable of being disconnected from the access point.

18. The system of claim 17, wherein the device policy generated for each of the one or more devices further indicates temporal information related to whether each of the one or more devices is capable of being disconnected from the access point.

19. The system of claim 15, wherein executing the instructions causes the system to perform operations, comprising:
for the access point operating in the low-power state, obtaining a trigger from a particular device that seeks to connect with the access point, wherein the trigger causes the access point to enter into the full-power state.

20. The system of claim 15, wherein executing the instructions causes the system to perform operations, comprising:
providing to the one or more devices an indication that power management capabilities are provided for the wireless local area network.
